(19) United States
(12) Patent Application Publication
(10) Pub. No.: US 2015/0023613 A1
(43) Pub. Date: Jan. 22, 2015

(54) Container Three

(71) Applicant: William Warren, Frisco, TX (US)

(72) Inventor: William Warren, Frisco, TX (US)

(21) Appl. No.: 14/287,133

(22) Filed: May 26, 2014

Related U.S. Application Data
(60) Provisional application No. 61/855,947, filed on May 28, 2013.

(51) Int. Cl. B65F 1/00; B65F 1/14

(52) U.S. Cl. CPC B65F 1/0006; B65F 1/14
USPC 383/3

(57) ABSTRACT

A trash container for holding trash may include a flexible first sidewall, a flexible second sidewall opposed and in a spaced relationship to the first sidewall to define a cavity, a bottom rigid wall connected to the flexible first sidewall and the flexible second sidewall to seal the cavity, and a top ring connected to the flexible first sidewall and the flexible second sidewall to seal the cavity.

### PRIORITY

The present application claims priority under 35 USC section 119 based upon a provisional application with a Ser. No. 61/855,947 which was filed on May 28, 2013.

### FIELD OF THE INVENTION

The present invention relates to trash containers and more particularly to a trash container having flexible walls.

### BACKGROUND

Trash is a common problem around the home, office and out of doors. in order to collect this trash, trash cans have been used. However, these trash cans can be small and generally have rigid sidewalls. The rigid sidewalls prevent the trash cans from being flattened out and stored in a relatively small space. What is needed is a trash can which can be easily deployed and easily stored in a limited space.

### SUMMARY

A trash container for collecting trash may include an outer container having a first cavity and an inner container being detachably connected to the outer container and being positioned within the first cavity. The outer container may include a bottom first wall, opposing first side walls and a back first wall to define the first cavity. The inner container may include a bottom inner wall, the opposing inner sidewalls and a back inner wall to define a second cavity.

The container may have an inflatable frame in between outer and inner walls.

The container may have a fused bottom floor into a singular floor, supporting the frame.

The container may be inflatable by an inflation tube.

The bottom wall may be rectangular.

The top ring may be circular.

The top ring may be oval or any geometric shape.

The trash container may include a release valve.

The trash container may include a cleat.

### FIELD OF THE INVENTION

The present invention relates to trash containers and more particularly to a trash container having flexible walls.

### BACKGROUND

Trash is a common problem around the home, office and out of doors. In order to collect this trash, trash cans have been used. However, these trash cans can be small and generally have rigid sidewalls. The rigid sidewalls prevent the trash cans from being flattened out and stored in a relatively small space. What is needed is a trash can which can be easily deployed and easily stored in a limited space.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a trash container of the present invention;

FIG. 1a illustrates a perspective view of the trash container of the present invention;

FIG. 2 illustrates a perspective view of the trash container of the present invention;

FIG. 2a illustrates a partial view of the trash container of the present invention;

FIG. 3 illustrates another embodiment of the trash container of the present invention;

FIG. 3a illustrates a top perspective view of the trash container of the present invention;

FIG. 4 illustrates a side perspective view of the trash container of the present invention;

FIG. 5 illustrates a front perspective view of the trash container of the present invention.

### DETAILED DESCRIPTION

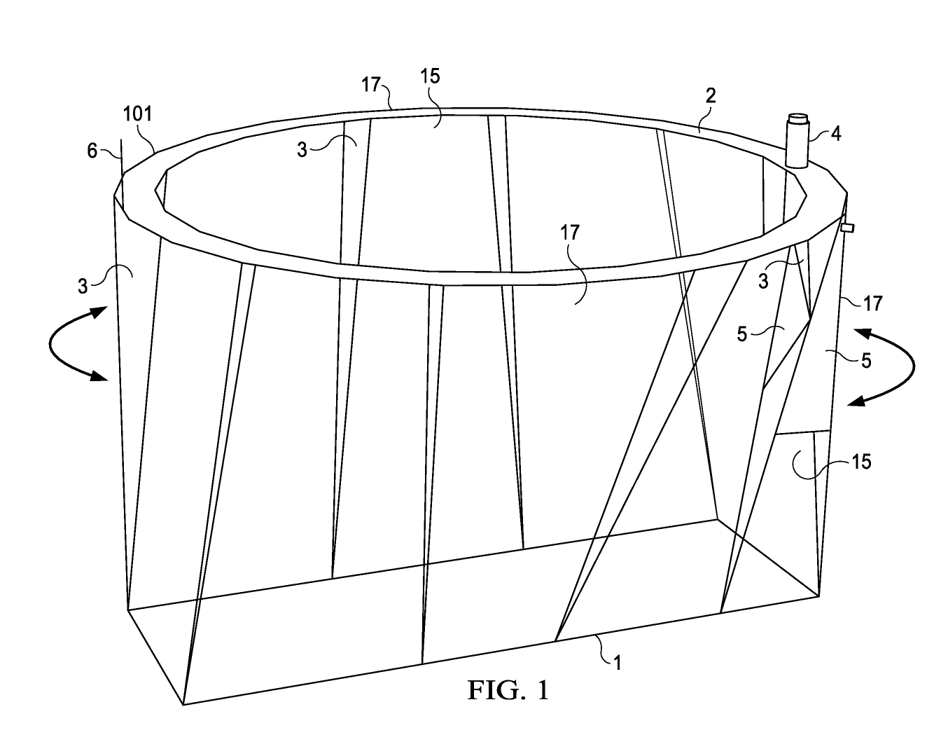

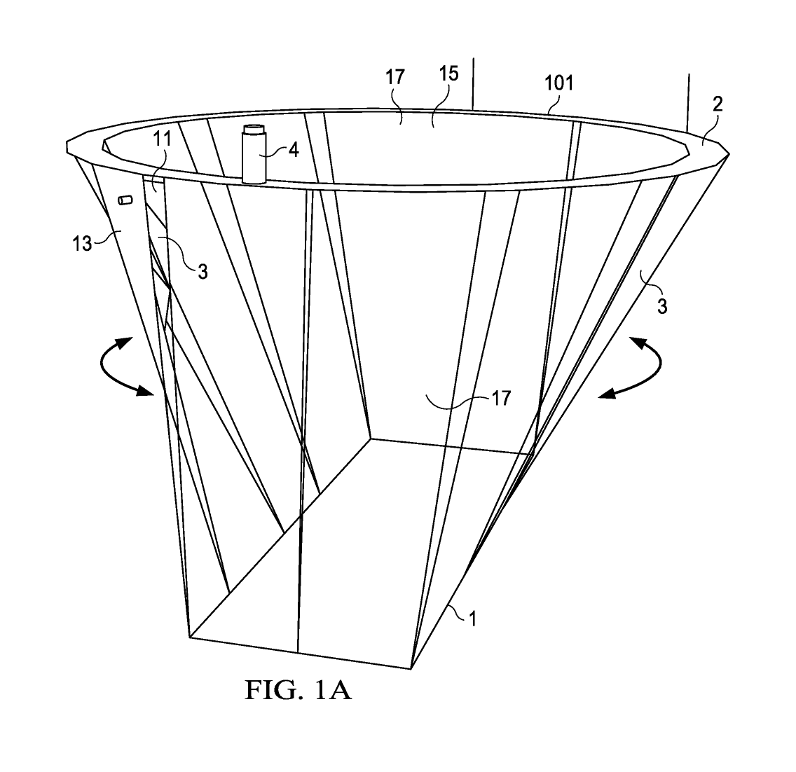

FIG. 1 illustrates a perspective view of the trash container 100 of the present invention including a flexible frame 101 which may include a bottom wall 1 which may be connected to an inner sidewall 11 and may be connected to an outer sidewall 13. The inner sidewall 11 and the outer sidewall 13 may completely extend around the periphery of the bottom wall 1, and the inner wall 11 and the outer wall 13 may be positioned in a spaced relationship to define a cavity 3 which may be filled with fluid which may be a liquid such as water or a gas such as air in order to maintain the spaced relationship between the inner wall 11 and the outer wall 13 and so that the inner wall 11 and the outer wall 13 extend upwards from the bottom wall 3. The bottom wall 1 may be shaped as a rectangle, oval, square, circle or other appropriate shape.

The inner sidewall 11 and the outer sidewall 13 may be flexible and may connect and may completely extend to and around a top peripheral wall which may be a top peripheral ring 2 which may form a seal with the inner sidewall 11 and the outer sidewall 13.

Furthermore, the bottom wall 1 may form a seal with the inner sidewall 11 and the outer sidewall 13. The peripheral ring 2 may be a circle, oval or other appropriate shape. The peripheral ring 2 may be flexible and may define an opening 15 into a holding cavity 17 for users to place trash and be held until pick up.

FIG. 1 additionally illustrates an inflation tube 4 to inflate the cavity 3 and may include a valve or may include a sealing cap to seal the inflation tube 4. The material of the bottom wall 1, the top ring 2, the inner sidewall 11 and the outer sidewall 13 may be formed from flexible or rigid material or may be formed from thin plastic sheets such as the material for forming the hefty or glad bags. The bottom wall I may be rigid and may be solid.

FIG. 1a illustrates a perspective view of the trash container 100 of the present invention which may include a bottom wall 1 which may be connected to an inner sidewall 11 and may be connected to an outer sidewall 13. The inner sidewall 11 and the outer sidewall 13 may be flexible and may completely extend around the periphery of the bottom wall 1, and the inner wall 11 and the outer wall 13 may be positioned in a spaced relationship to define a cavity 3 which may be filled with fluid which may be a liquid such as water or a gas such as air in order to maintain the spaced relationship between the inner wall 11 and the outer wall 13 and so that the inner wall 11 and the outer wall 13 extend upwards from the bottom wall 3. The bottom wall 1 may be shaped as a rectangle, oval, square, circle or other appropriate shape.

The inner sidewall 11 and the outer sidewall 13 may connect and may completely extend to and around a top peripheral wall which may be flexible and may be a top peripheral ring 2 which may form a seal with the inner sidewall 11 and the outer sidewall 13. Furthermore, the bottom wall 1 may form a seal with the inner sidewall 11 and the outer sidewall 13. The peripheral ring 2 may be a circle, oval or other appropriate shape. The peripheral ring 2 may define an opening 15 into a holding cavity 17 for users to place trash and be held until pick up.

FIG. 1a additionally illustrates an inflation tube 4 to inflate the cavity 3 and may include a valve or may include a sealing cap to seal the inflation tube 4. The material of the bottom wall 1, the top ring 2, the inner sidewall 11 and the outer sidewall 13 may be formed from flexible or rigid material or may be formed from thin plastic sheets such as the material for forming the hefty or glad bags. The bottom wall 1 may be rigid and may be solid.

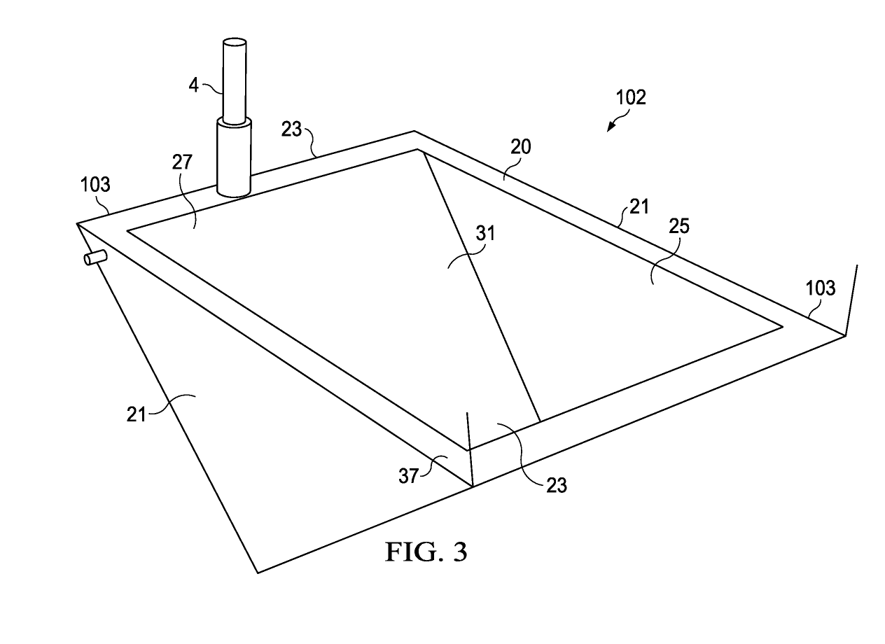

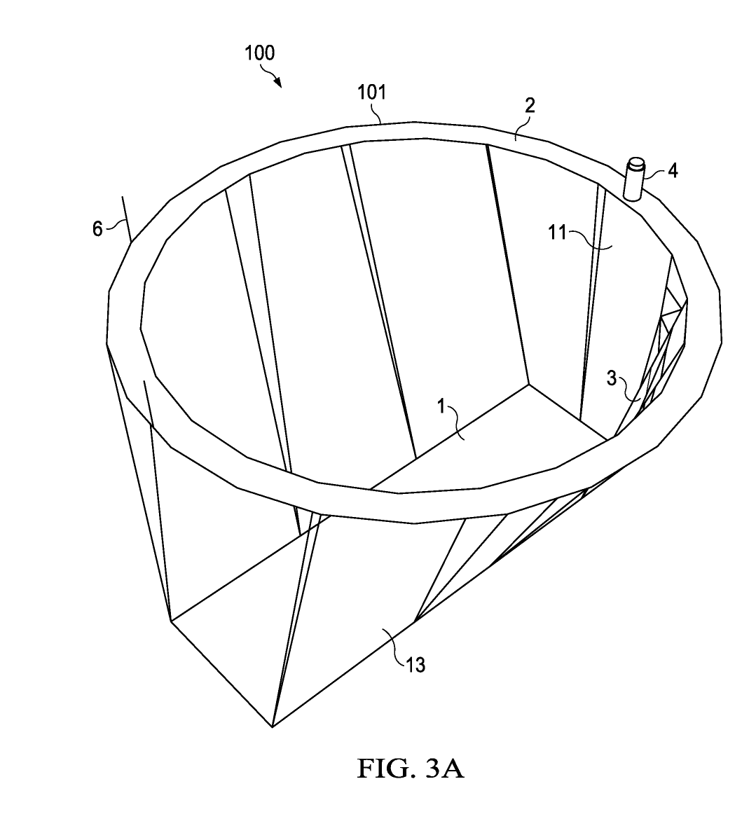

FIG. 3 illustrates another trash container 102 of the present invention including a flexible frame 103 which may include a pair of opposing first outer mirror sidewalls 21 which may be substantially triangular in shape and which may be connected to a pair of opposing second outer mirror sidewalls 23 which may be connected to form a continuous periphery of the first outer mirror sidewalls 21 which may be flexible. The second outer mirror sidewalls 23 may be flexible and may be substantially rectangular in shape.

The trash container 102 may include a pair of opposing first inner mirror sidewalls 25 which may be flexible and may be substantially triangular in shape and which may be in a spaced relationship with the first outer mirror sidewalls 21 defining a cavity 37 between the first inner mirror sidewalls 25 and the first outer mirror sidewalls 21 which may be flexible and which may be connected to a pair of opposing second inner mirror sidewalls 27 which may be flexible in a spaced relationship with the second outer mirror sidewalls 23 defining a cavity 37 between the second inner mirror sidewalls 27 and the second outer mirror sidewalls 23. The first inner mirror sidewalls 25 and the second inner mirror sidewalls 27 may be connected around a continuous periphery of the first inner mirror sidewalls 25 and the second inner mirror sidewalls 27.

FIG. 3 additionally illustrates an inflation tube 4 to inflate the trash container 102. The cavity 37 may be filled with fluid including a gas or liquid such as air or water.

The trash container 102 additionally includes a top peripheral wall 20 which may be flexible and may extend around and seal the first outer mirror sidewalls 21, the second outer sidewalls 23, the first inner mirror sidewalls 25 and the second inner mirror sidewalls 27. The first and second inner mirror sidewalls 25, 27 define a holding cavity 31 where trash may be stowed and the holding cavity 31 may include an opening 33 to allow the trash to enter the holding cavity 31.

The top peripheral wall 20 may be connected to tie straps 35.

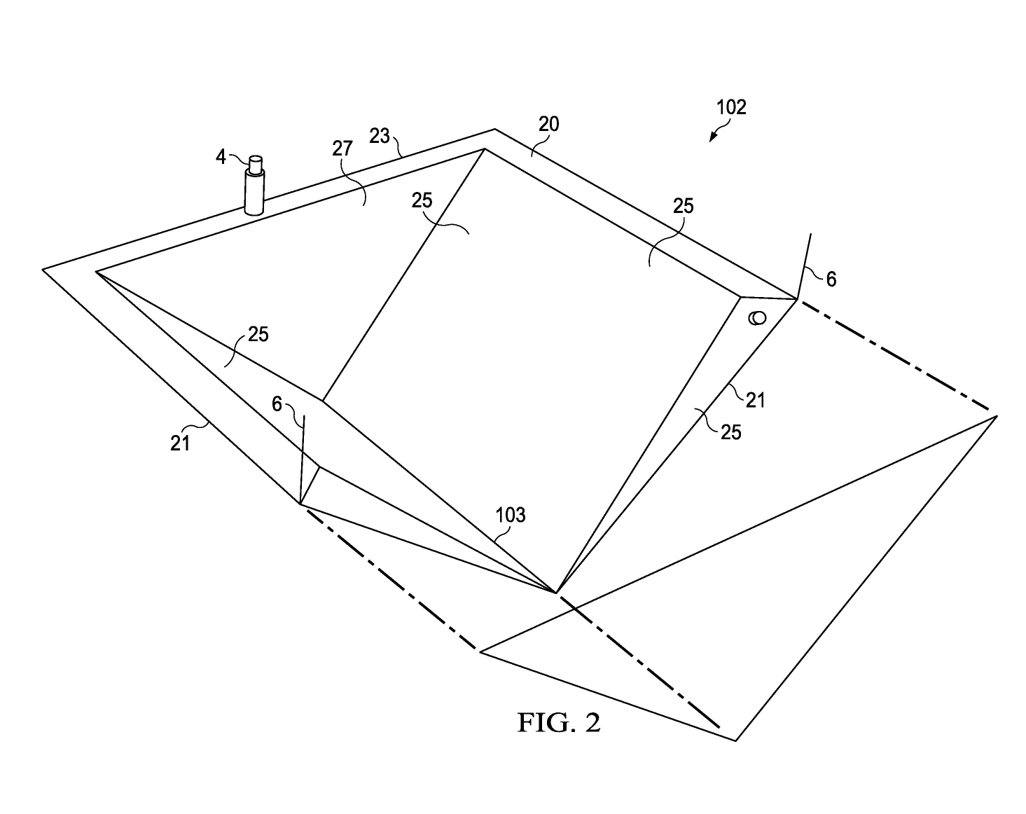

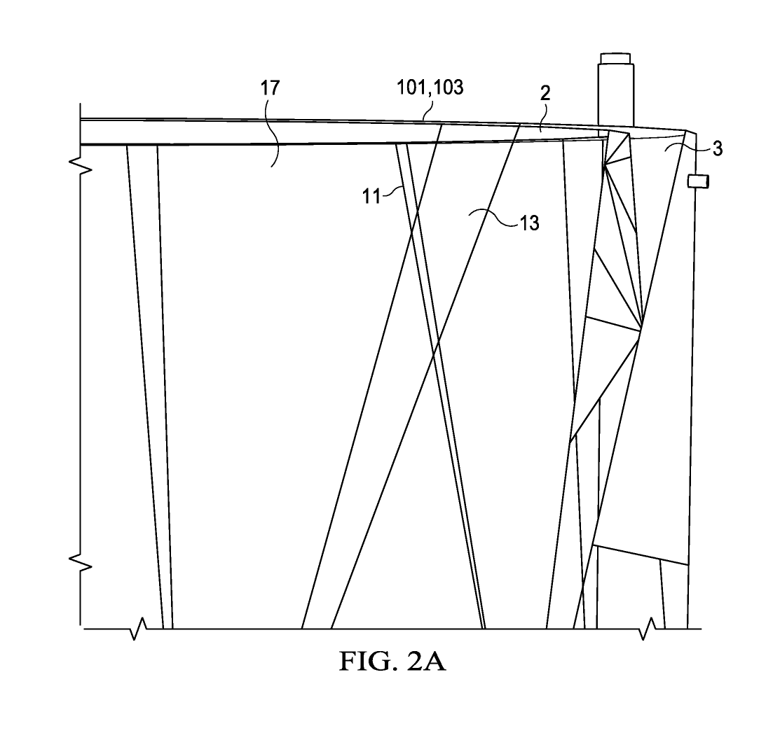

FIG. 2 illustrates the trash container 102 having the top peripheral wall 20, the first outer mirror sidewalls 21, the second outer mirror sidewalls 23, the first inner mirror sidewalls 25 and the second inner mirror sidewalls 27 (all flexible) only extending around two sides of the trash container 102 to provide enhanced access to the holding cavity 31.

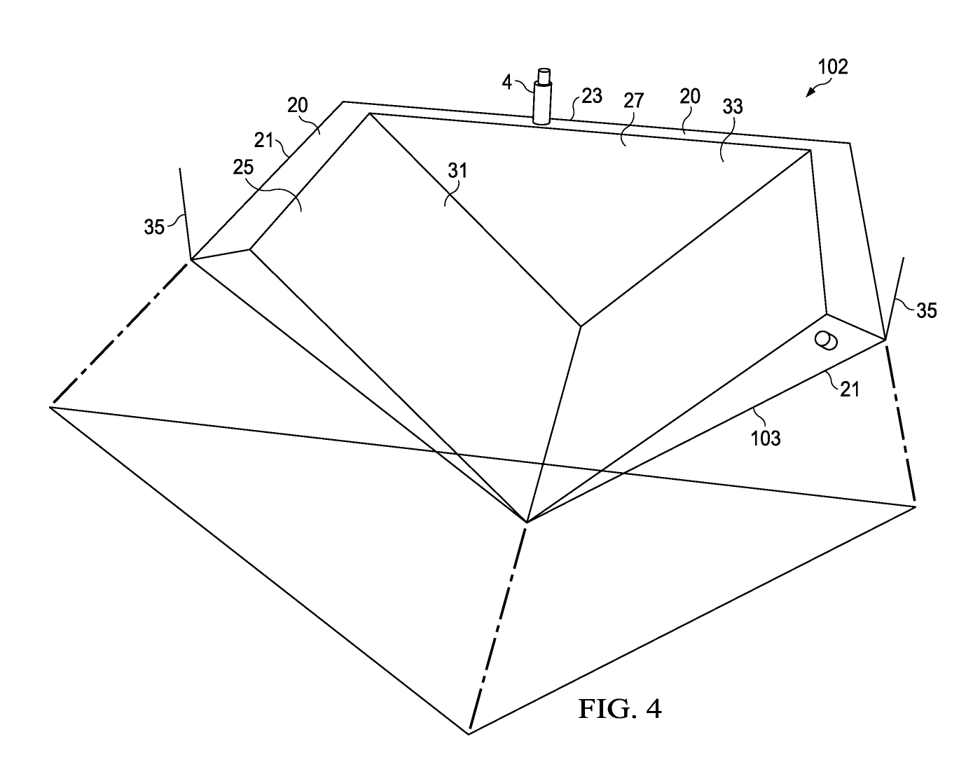

FIG. 4 illustrates the trash container 102 having the top peripheral wall 20, the first outer mirror sidewalls 21, the second outer mirror sidewalls 23, the first inner mirror sidewalls 25 and the second inner mirror sidewalls 27 (all flexible) only extending around two sides of the trash container 102 to provide enhanced access to the holding cavity 31.

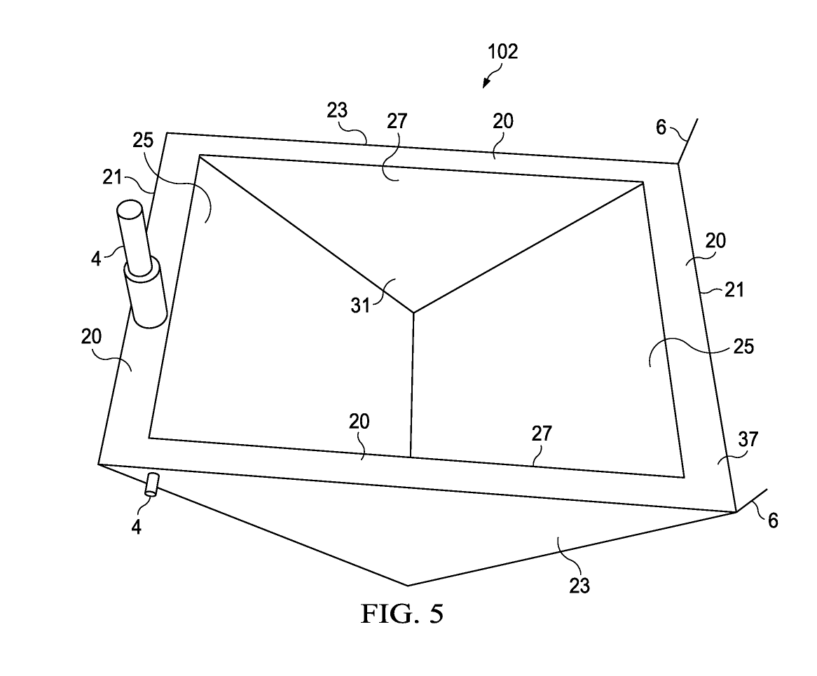

FIG. 5 illustrates another trash container 102 of the present invention which may include a pair of opposing first outer mirror sidewalls 21 which may be flexible and may be substantially triangular in shape and which may be connected to a pair of opposing second outer mirror sidewalls 23 which may be flexible and may be connected around a continuous periphery of the first outer mirror sidewalls 21. The second outer mirror sidewalls 23 may be flexible and may be substantially rectangular in shape.

The trash container 102 may include a pair of opposing first inner mirror sidewalls 25 which may be flexible and may be substantially triangular in shape and which may be in a spaced relationship with the first outer mirror sidewalls 21 defining a cavity 37 between the first inner mirror sidewalls 25 and the first outer mirror sidewalls 21 and which may be flexible and may be connected to a pair of opposing second inner mirror sidewalls 27 in a spaced relationship with the second outer mirror sidewalls 23 defining a cavity 37 between the second inner mirror sidewalls 27 and the second outer mirror sidewalls 23. The first inner mirror sidewalls 25 and the second inner mirror sidewalls 27 may be connected around a noncontinuous periphery of the first inner mirror sidewalls 25 and the second inner mirror sidewalls 27.

FIG. 5 additionally illustrates an inflation tube 4 to inflate the trash container 102. The cavity 37 may be filled with fluid including a gas or liquid such as air or water.

The trash container 102 additionally includes a top peripheral wall 20 which may be flexible and may extend around and seal the first outer mirror sidewalls 21, the second outer sidewalls 23, the first inner mirror sidewalls 25 and the second inner mirror sidewalls 27. The first and second inner mirror sidewalls 25, 27 define a holding cavity 31 where trash may be stowed and the holding cavity 31 may include an opening 33 to allow the trash to enter the holding cavity 31.

FIG. 3a illustrates a perspective view of the trash container 100 of the present invention which may include a bottom wall 1 which may be connected to an inner sidewall 11 and may be connected to an outer sidewall 13. The inner sidewall 11 and the outer sidewall 13 may completely extend around the periphery of the bottom wall 1, and the inner wall 11 and the outer wall 13 may be positioned in a spaced relationship to define a cavity 3 which may be filled with fluid which may be a liquid such as water or a gas such as air in order to maintain the spaced relationship between the inner wall 11 and the outer wall 13 and so that the inner wall 11 and the outer wall 13 extend upwards from the bottom wall 3. The bottom wall 1 may be shaped as a rectangle, oval, square, circle or other appropriate shape.

The inner sidewall 11 and the outer sidewall 13 may connect and may completely extend to and around a top peripheral wall which may be a top peripheral ring 2 which may form a seal with the inner sidewall 11 and the outer sidewall 13. Furthermore, the bottom wall 1 may form a seal with the inner sidewall 11 and the outer sidewall 13. The peripheral ring 2 may be a circle, oval or other appropriate shape. The peripheral ring 2 may define an opening 15 into a holding cavity 17 for users to place trash and be held until pick up.

FIG. 3a additionally illustrates an inflation tube 4 to inflate the cavity 3 and may include a valve or may include a sealing cap to seal the inflation tube 4. The material of the bottom wall 1, the top ring 2, the inner sidewall 11 and the outer sidewall 13 may be formed from flexible or rigid material or may be formed from thin plastic sheets such as the material for forming the hefty or glad bags. The bottom wall 1 may be rigid and may be solid.

FIG. 2a illustrates the cavity 3 defined by the bottom wall 1, the inner sidewall 11 and the outer sidewall 13.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A trash container for holding trash, comprising: a flexible first sidewall;
a flexible second sidewall opposed and in a spaced relationship to the first sidewall to define a cavity;
a bottom flexible wall connected to the flexible first sidewall and the flexible second sidewall to seal the cavity;
a top ring connected to the flexible first sidewall and the flexible second sidewall to seal the cavity,

2. A trash container for holding trash as in claim 1, wherein a flexible frame inflated with gas or liquid.

3. A trash container for holding trash as in claim 1, wherein the top ring is circular.

4. A trash container for holding trash as in claim 1, wherein the top ring is oval.
A trash container for holding trash as in claim 1, wherein the top ring is any geometric shape.

5. A trash container for holding trash as in claim 1, when the trash container includes a bottom wall that is fused into 1 layer, no cavity between two layers.

6. A trash container for holding trash as in claim 1, wherein the trash container includes a cleat.

7. A trash container for holding trash as in claim 1, wherein the bottom wall forms a rectangle, oval, square, circle or any geometric shape

8. A trash container for holding trash as in claim 1,
wherein the bottom wall forms a meeting point of the 2 sides which forges a v shape pointed bottom area.

9. A trash container for holding trash as in claim 1, wherein air between, two plastic sheets, sheets can be flexible or non flexible

10. A trash container for holding trash as in claim 1, wherein air in between, any type of material that has the physical properties to hold air

11. A trash container for holding trash as in claim 1, wherein air between, any type of material that has the physical properties to hold air to form a trash container

12. A trash container for holding trash as in claim 1, wherein gas or fluid in between flexible materials

13. A trash container for holding trash as in claim 1, wherein quick air or fluid release valve connected to a frame

14. A trash container for holding trash as in claim 1, wherein inflating valve on a frame.

15. A trash container for holding trash as in claim 1, wherein the lowest floor does not have cavity in between another bottom floor, forming a singular floor.

16. A trash container for holding trash as in claim 1, wherein the bottom floor has a cavity in between 2 bottom floors.
